(19) United States
(12) Patent Application Publication
(10) Pub. No.: US 2021/0064518 A1
(43) Pub. Date: Mar. 4, 2021

(54) Methods Circuits Devices Systems and Functionally Associated Machine Executable Code For Automatic Failure Cause Identification in Software Code Testing

(71) Applicant: Shield34 LTD., Nazareth (IL)

(72) Inventors: Wael Abu Taha, Nazareth (IL); Firas Matar, Nof-Hagalil (IL); Ran Finkelstein, Tzur-Yitzhak (IL); Ameer Abu-Zhaya, Nof-Hagalil (IL); Deeb Andrawis, Turaan (IL)

(73) Assignee: Shield34 LTD., Nazareth (IL)

(21) Appl. No.: 17/004,057

(22) Filed: Aug. 27, 2020

Related U.S. Application Data
(60) Provisional application No. 62/892,008, filed on Aug. 27, 2019.

(51) Int. Cl. G06F 11/36; G06N 20/00

(52) U.S. Cl. CPC G06F 11/3688; G06F 11/3664; G06N 20/00

(57) ABSTRACT

Disclosed are methods, circuits, devices, systems and functionally associated machine executable code for enhanced automated software code testing. A system for enhanced automated software code testing comprises a processing module for wrapping test script commands, of a software testing framework, with command execution monitoring or control code. The command execution monitoring or control code, is configured to collect and report test script execution parameters, resulting from test script executions. A failure root cause identification module automatically determines one or more root causes of a failure in the execution of a test script run, based on the analysis of test script execution parameters from prior test runs.

### RELATED APPLICATIONS SECTION

The present application claims priority from U.S. Provisional Patent Application No. 62/892,008, filed Aug. 27, 2019, which application is hereby incorporated by reference in its entirety.

### FIELD OF THE INVENTION

The present invention generally relates to the field of automated software code testing. More specifically, the present invention relates to methods, circuits, devices, systems and functionally associated machine executable code for enhanced automated software code testing and automatic failure cause identification in software code testing.

### BACKGROUND

Software testing is an investigation conducted to provide stakeholders with information about the quality of the software product or service under test. Software testing can also provide an objective, independent view of the software to allow the business to appreciate and understand the risks of software implementation. Test techniques include the process of executing a program or application with the intent of finding software bugs (errors or other defects), and verifying that the software product is fit for use.

Software testing involves the execution of a software component or system component to evaluate one or more properties of interest. In general, these properties indicate the extent to which the component or system under test: meets the requirements that guided its design and development, responds correctly to all kinds of inputs, performs its functions within an acceptable time, is sufficiently usable, can be installed and run in its intended environments, and/or achieves the general result its stakeholders desire.

As the number of possible tests for even simple software components is practically infinite, all software testing uses some strategy to select tests that are feasible for the available time and resources. As a result, software testing typically (but not exclusively) attempts to execute a program or application with the intent of finding software bugs (errors or other defects). The job of testing is an iterative process as when one bug is fixed, it can illuminate other, deeper bugs, or can even create new ones.

Software testing can provide objective, independent information about the quality of software and risk of its failure to users or sponsors.

Software testing can be conducted as soon as executable software (even if partially complete) exists. The overall approach to software development often determines when and how testing is conducted. For example, in a phased process, most testing occurs after system requirements have been defined and then implemented in testable programs. In contrast, under an agile approach, requirements, programming, and testing are often done concurrently.

A common practice nowadays, is the use of portable frameworks, Selenium for example, for testing web applications. Testing frameworks, such as Selenium, often provide a playback tool for authoring functional tests without the need to learn a test scripting language. They may also provide a test domain-specific language to write tests in a number of popular programming languages, including for example: C #, Groovy, Java, Perl, PHP, Python, Ruby and Scala. The tests can then run against most modern web browsers. Such testing frameworks may be deployed on various operating systems, Selenium open-source software for example, deploys on Windows, Linux, and macOS platforms.

Still, popular open source test automation tools suffer from multiple pain points. There remains a need, in the field of automated software testing, for testing optimization and facilitation solutions for minimizing flaky tests, performing deeper test analysis, generating and providing higher level test reports, and shortening test runs—while enabling coding over familiar languages/platforms such as Selenium.

### SUMMARY OF THE INVENTION

Embodiments of the present invention include methods, circuits, devices, systems and functionally associated machine executable code for enhanced automated software code testing and for automatic failure cause identification in software code testing. According to certain embodiments of the present invention, raw commands from a test script of a software testing framework are examined and preprocessed, by a preprocessing module, before submission for execution within the testing framework. Preprocessing of a command may include reconfiguration of one or more command parameters, wrapping the original script command within additional execution monitoring and/or control code. Preprocessing of a command may also include queuing and/or ordering the command relative to other commands within the test script. Preprocessing of a command may also include queuing and/or ordering the command relative to detection of events occurring responsive the execution of the test script. Processing of application test script may be performed automatically through a test script ingestion and processing module. Test script command handling according to some events may be performed by a command handling module which may read and handle the test script in accordance with instructions and parameters added by the preprocessing module.

According to further embodiments, command wrapping may include the addition or insertion of test execution monitoring code/functionality. Monitoring code may be configured to sense, measure and report test script execution parameters, resulting from test script execution, such as for example: (1) appearance/creation of screen objects/elements; (2) exception notifications; (3) computing resource (e.g. CPU load, memory usage, storage access rates and/or networking access rates) usage and/or load; and/or (4) API behavior. According to embodiments, monitoring code may, responsive to monitoring test code execution, report results of said monitoring back to a test execution monitoring module. The test execution monitoring module according to embodiments may receive, aggregate, organize, filter and present for review (e.g. through a rendered dashboard) monitoring data provided by one or more segments of monitoring code.

According to further embodiments, preprocessing is done according to best practices rules. Execution of test script may be guided by the test execution monitoring module, monitoring output and execution rules. Test script execution guiding, in accordance with monitored output and execution rules, may include waiting for a set of one or more required preconditions to be fulfilled, prior to executing the command. Test script execution guiding may also include detection of command execution exceptions, wherein the execution of a command, for which one or more execution exceptions were detected, may be automatically retried. Test script execution guiding may also include verifying successful, and optionally complete, execution of a command, wherein the unsuccessful and/or incomplete execution of a command, for which no execution exceptions were detected, may be automatically retried.

Exceptions in the execution, and/or an unsuccessful verification, of an executed command, may automatically trigger its re-execution. Test script execution guiding, in accordance with some embodiments, may limit the number of retried executions of a given command, wherein upon reaching a threshold number of unsuccessful retried executions—a feedback request, an execution failure notice and/or a suggested test script change may be generated.

According to some embodiments, the execution monitoring or control code, may gather test script command/run execution data records, wherein gathered data records may be logged in a structured format. Accumulated logged data records of a set of test script command executions may be analyzed to extract informative features associated with the execution of a test script, or test script command, not in the set. Extracted features may be used to estimate or determine the root cause of a test script run failure.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1, is a high level block diagram of an exemplary system for enhanced automated software code testing, in accordance with some embodiments of the present invention;

FIG. 2, is a block diagram of an exemplary system for enhanced automated software code testing, in accordance with some embodiments of the present invention, wherein system modules and interrelations there between are shown in further details;

FIG. 3, is a flowchart showing the main steps executed as part of an exemplary process for performing a test framework (Selenium) ‘Click’, wherein the test is monitored by added or inserted test execution monitoring code/functionality, in accordance with some embodiments of the present invention;

FIG. 4, is a flowchart showing the main steps executed as part of an exemplary process for performing a test framework (Selenium) ‘Driver findElement’, wherein the test is monitored by added or inserted test execution monitoring code/functionality, in accordance with some embodiments of the present invention;

FIG. 5, is a block diagram of an exemplary system for enhanced automated software code testing, in accordance with some embodiments of the present invention, wherein the system includes a failure root cause identification module;

FIG. 6A, is a block diagram of an exemplary failure root cause identification module, in accordance with some embodiments of the present invention; and

FIG. 6B, is a block diagram of an exemplary structured execution data analysis block and an exemplary failure root cause identification logic, in accordance with some embodiments of the present invention, wherein the analysis block and the identification logic are shown in further detail.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

Embodiments of the present invention include methods, circuits, devices, systems and functionally associated machine executable code for enhanced automated software code testing and for automatic failure cause identification in software code testing. According to certain embodiments of the present invention, raw commands from a test script of a software testing framework are examined and preprocessed, by a preprocessing module, before submission for execution within the testing framework. Preprocessing of a command may include reconfiguration of one or more command parameters, wrapping the original script command within additional execution monitoring and/or control code. Preprocessing of a command may also include queuing and/or ordering the command relative to other commands within the test script. Preprocessing of a command may also include queuing and/or ordering the command relative to detection of events occurring responsive the execution of the test script. Processing of application test script may be performed automatically through a test script ingestion and processing module. Test script command handling according to some events may be performed by a command handling module which may read and handle the test script in accordance with instructions and parameters added by the preprocessing module.

According to further embodiments, command wrapping may include the addition or insertion of test execution monitoring code/functionality. Monitoring code may be configured to sense, measure and report test script execution parameters, resulting from test script execution, such as for example: (1) appearance/creation of screen objects/elements; (2) exception notifications; (3) computing resource (e.g. CPU load, memory usage, storage access rates and/or networking access rates) usage and/or load; and/or (4) API behavior. According to embodiments, monitoring code may, responsive to monitoring test code execution, report results of said monitoring back to a test execution monitoring module. The test execution monitoring module according to embodiments may receive, aggregate, organize, filter and present for review (e.g. through a rendered dashboard) monitoring data provided by one or more segments of monitoring code.

According to further embodiments, preprocessing is done according to best practices rules. Execution of test script may be guided by the test execution monitoring module, monitoring output and execution rules. Test script execution guiding, in accordance with monitored output and execution rules, may include waiting for a set of one or more required preconditions to be fulfilled, prior to executing the command. Test script execution guiding may also include detection of command execution exceptions, wherein the execution of a command, for which one or more execution exceptions were detected, may be automatically retried. Test script execution guiding may also include verifying successful, and optionally complete, execution of a command, wherein the unsuccessful and/or incomplete execution of a command, for which no execution exceptions were detected, may be automatically retried.

Exceptions in the execution, and/or an unsuccessful verification, of an executed command, may automatically trigger its re-execution. Test script execution guiding, in accordance with some embodiments, may limit the number of retried executions of a given command, wherein upon reaching a threshold number of unsuccessful retried executions—a feedback request, an execution failure notice and/or a suggested test script change may be generated.

According to some embodiments of the present invention, a system for enhanced automated software code testing and for automatic failure cause identification in software code testing may wrap test script commands, of a software testing framework, with command execution monitoring or control code. The system, in accordance with some embodiments, may include a Failure Root-Cause Identification Module for estimating, determining and/or predicting the root-cause of a test script execution failure(s), based on execution related data gathered and provided by the command execution monitoring or control code.

The command execution monitoring or control code, in accordance with some embodiments, may gather test script command/run execution data records, wherein gathered data records may be logged in a structured format.

According to some embodiments, gathered execution data records may be formatted, reported and/or logged, by an Execution Data Logging/Formatting Logic, as a structured data records combination, consisting, for example, of any combination of the following exemplary records:

(1) Execution exceptions—for example: irregular test execution behaviors (e.g. times to complete, parameter values) in accordance with any of the embodiments or examples described and provided herein.
(2) Execution test steps—for example: test steps and/or commands executed, repeated, skipped, aborted and/or elsewise specifically treated as part of a specific given test type.
(3) Execution Environment/Browser—for example: browser console operation records, browser network resource usage, browser storage resource usage and/or browser cookies usage parameters.
(4) Operating System Details—for example: the type, model, version and/or other details of the operating system running on the machine which the test script is executed on.
(5) Browser Details—for example: the type, model, version and/or other details of the browser which the test script is executed on/for.
(6) Machine Details—for example: the type, model, version, resource operation/usage records and/or other details of the CPU and/or Memory of the machine which the test script is executed on.
(7) Web/Browser Page Details—for example: page construction code, such as: HTML, JS or CSS segments and/or graphic sections or elements rendered/to-be-rendered as part of the page's visual presentation.

According to some embodiments, accumulated logged data records of a set of test script command executions may be analyzed to extract informative features associated with the execution of a test script command not in the set.

According to some embodiments, a Structured Execution Data Analysis Block may comprise and apply one or more data processing, machine-learning and/or artificial intelligence algorithms, logics or models, onto at least part of the accumulated logged data records—of failed, or of successful, automated software tests—in the set of test script command executions, in order to automatically identify the root cause(s) of a failure in the execution of a test script command/execution/run not in the set (e.g. new, current).

According to some embodiments, the one or more machine-learning algorithms or models applied, may be software and/or hardware logic implemented and, may include any combination of the following systems, methods, models, algorithms and/or solutions.

According to some embodiments, a sequence alignment logic may apply alignment algorithms to different data record logs pertaining to the same, or a substantially similar, test type. Log sequence pairing/matching analysis may be performed to extract informative features based on the partial overlap(s)/pairing(s), and/or the remaining delta(s), found between two or more data record logs pertaining to different executions of an identical or substantially similar test type.

According to some embodiments, an execution setting logic may utilize: statistical, document-retrieval and natural language processing tools and techniques, for feature extraction from within test script command executions' steps and the setting of log entries, protocol data, and error messages associated therewith.

Extracted execution steps features may be utilized by the sequence alignment logic to match between differently sequenced/ordered steps of different test executions. Accordingly, steps of a successful test execution, or a test execution order/scheme generated based on multiple successful test executions, may be compared, matched and then aligned—with the steps of a following, failed, test run execution. Step aligned successful and failed executions may then be used to compare corresponding steps of the two executions and extract the deltas/differences between the corresponding steps, thus highlighting specific failed test characteristics which differ from those of a successful test execution/execution-scheme.

According to some embodiments, an execution flow modeling logic may utilize process mining algorithms to generate a ‘successful/normal test execution model’ (e.g. a test execution order/scheme generated based on multiple successful test executions), based on at least part of the set of previous test execution runs, logged in a structured format and determined to be successful/normal.

The execution flow modeling logic may compare the ‘successful/normal test execution model’ to the flow of a newly executed (i.e. not in the set) test script command/run to identify deviations there between, characterize them, classify them and/or correlate them to specific execution failures/problems and optionally to causes/root-causes thereof.

According to some embodiments, test script command/run execution data records logged in a structured format, may be used as training data for the supervised learning process of a neural network. Logged test script run records, of multiple runs, may be entered/provided/inputted to the supervised learning model along with their respective, previously determined, root causes. The generated model may then be utilized to classify the results/logged-records of a newly executed, failed, test script command/run to the root cause(s) of the failure.

According to some embodiments, test script command/run execution data records logged in a structured format, may be analyzed by a root cause plausibility factoring logic for identifying plausible/reoccurring type/sets/patterns of root causes. Ensemble stacking techniques, ordinal regression techniques and/or human/expert review/curating feedbacks, may be utilized for quantifying—based on the identified plausible/reoccurring root causes—the level of confidence in respect to each of a set of optional failure root-causes for a newly executed, failed, test script command/run.

According to some embodiments, test script command/run execution data records logged in a structured format, may be used as training data for the unsupervised learning process of a neural network. Logged test script run records, of multiple runs, may be entered/provided/inputted to the unsupervised learning model for clustering and/or manifold-learning. Clusters/reductions generated by the neural network may be utilized to identify unknown execution failure modes/causes which are common through similarly clustered test script execution runs and/or to detect relations between failures, of either related, or unrelated, tests/runs.

According to some embodiments, clusters/reductions generated by the neural network and/or built hierarchical models may be used to group different failed test executions into groups having individual/specific root-causes. Records of failed test executions in the same root-cause group may be forensically examined to detect/identify common latent factors/behaviors/scenarios/value-sets associated with their execution failure. Latent factors identified as indicative of specific root-cause failure(s) may be then monitored/searched/scouted for as part of newly executed tests, wherein their latent factor indicated/forecasted root-cause failure(s) are estimated and handled/notified at an earlier execution stage based on a latent factor(s) detection.

According to some embodiments, test results of an executed test may be analyzed by a test results anomalies detection logic, wherein anomalies may be detected based on a comparison of the results to logged test script command/run execution data records associated with substantially similar previously executed tests. Detected anomalies may be utilized for feature extraction purposes, wherein extracted/searched—for features may be pinpointed/defined by characteristics of a detected anomaly—for example, its time of occurrence.

According to some embodiments, specific anomaly types may be defined and user warnings/notifications may be triggered upon their detection. Specific anomaly types may be defined to correlate-to/forecast execution failures; and/or may be defined to trigger user anomaly warnings/notifications for a set of specific detected anomalies, wherein each of the specific anomalies in the set does predict, or is not associated with an execution failure.

According to some embodiments, computer-vision algorithms may be applied on screen shots and/or video captures of test script code sets and/or test script execution monitoring user screens, to extract useful information enriching or replacing the information in the execution logs and execution test-results.

According to some embodiments, a combination of Analysis Block outputs/results/products, as described herein, may be relayed to, and processed by, a Failure Root-Cause Identification Logic to estimate, determine and/or predict the root-cause of a past/retrospective, present/real-time and/or future/forecasted test execution failure(s).

Analysis Block outputs, or data values representations thereof, may for example be utilized by the Failure Root-Cause Identification Logic to: (1) reference a table/data-store and retrieve failure root cause(s) matching/paired-to the received outputs/values; (2) compare the outputs/values with one or more threshold values, wherein the crossing of a set of specific one or more threshold values is associated with a respective failure root cause(s); and/or (3) utilize any combination of: decision mechanisms, rule-sets and/or AI or machine-learning models—described herein and/or known in the art—to estimate, determine and/or predict the root-cause of a test execution failure(s); and to relay/communicate a corresponding notification to a user interface device dashboard and/or a client application.

According to some embodiments, transfer learning and adaptive algorithms may be applied by the system as part of upscaling, migrating, and/or utilizing any combination of the functionalities, solutions and methodologies described herein—from one test-suite/test-framework/test-environment to another/other suite(s)/framework(s)/environment(s) on which it was not previously trained/utilized.

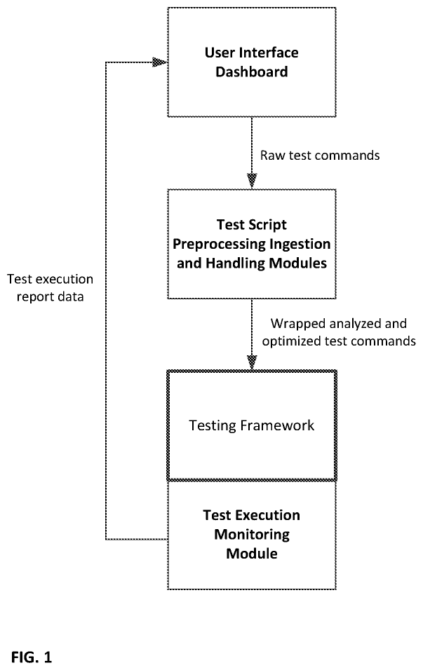

Reference is now made to FIG. 1, where there is shown a block diagram of an exemplary system for enhanced automated software code testing, in accordance with some embodiments of the present invention.

In the figure, raw test commands are shown to be relayed/uploaded from a user device, by the system's user interface dashboard. The system's test script processing modules, preprocesses the commands, wraps the commands with monitoring/control code, ques the wrapped commands and relays them for execution in the test framework.

The shown test execution monitoring module, guides the execution and processes feedback data provided by the monitoring code. Based on the processed feedback data, test execution report data is generated and communicated to the user interface dashboard for presentation.

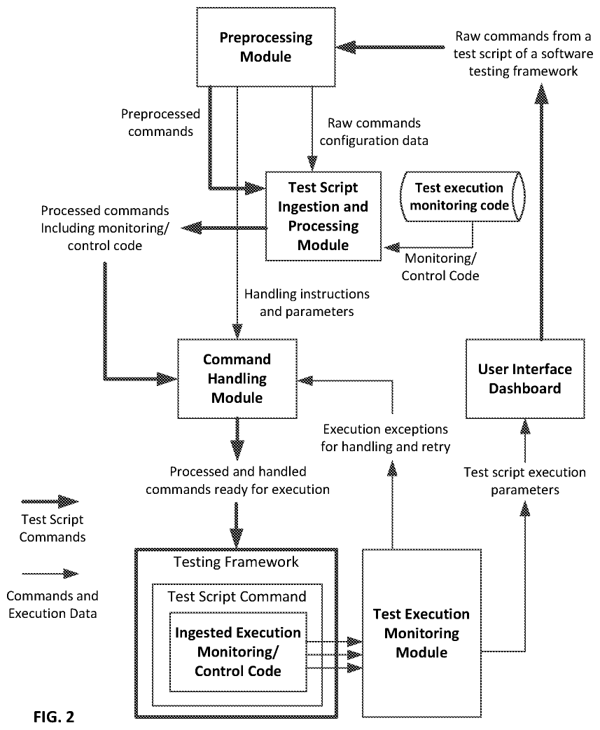

Reference is now made to FIG. 2, where there is shown a block diagram of an exemplary system for enhanced automated software code testing, in accordance with some embodiments of the present invention, wherein system modules and interrelations there between are shown in further details.

Raw commands from a test script of a software testing framework are examined and preprocessed, by a preprocessing module, before submission for execution within the testing framework. Preprocessing of the commands may include: (1) reconfiguration of one or more command parameters, wrapping the original script command within execution monitoring and/or control code; (2) queuing and/or ordering the command relative to other commands within the test script; and/or (3) queuing and/or ordering the command relative to detection of events occurring responsive the execution of the test script.

Processing of application test script is performed automatically through the shown test script ingestion and processing module using the stored/dynamically-generated monitoring/control code segments, for ingestion into the test script based on the received raw commands configuration data/instructions.

Test script command handling is performed by the shown command handling module that reads and handles the test script in accordance with instructions and parameters added and relayed by the preprocessing module. Handled commands are queued and relayed, by the command handling module, for test framework execution.

The execution monitoring/control code ingested into the test script commands senses, measures and reports test script execution parameters, resulting from execution of the enhanced/processed test script. The monitoring code, responsive to monitoring test code execution, reports the monitoring results back to the shown test execution monitoring module.

The test execution monitoring module receives, aggregates, organizes, filters and, relays for presentation and review—through the shown user interface dashboard rendered on a user device—monitoring data provided by, and/or generated based on, one or more segments of the executed monitoring/control code.

The execution of the test scripts is guided by the test execution monitoring module, monitoring execution outputs and execution rules. The test execution monitoring module guides the test script execution, in accordance with monitored output and execution rules. Execution exceptions and notifications, such as: (1) fulfillments of required preconditions for executing a command(s); (2) detections of command execution exceptions and the command execution retrying instructions; (3) verifications of successful, and optionally complete, execution of a command; (4) retrying instructions for unsuccessful and/or incomplete execution of a command, for which no execution exceptions were detected; and/or (5) parameters indicating the number of retried executions for specific test script commands—are relayed to: the user interface dashboard for user presentation and review; and/or, to the command handling module for queueing for retried, differed and/or repaired/changed-script execution.

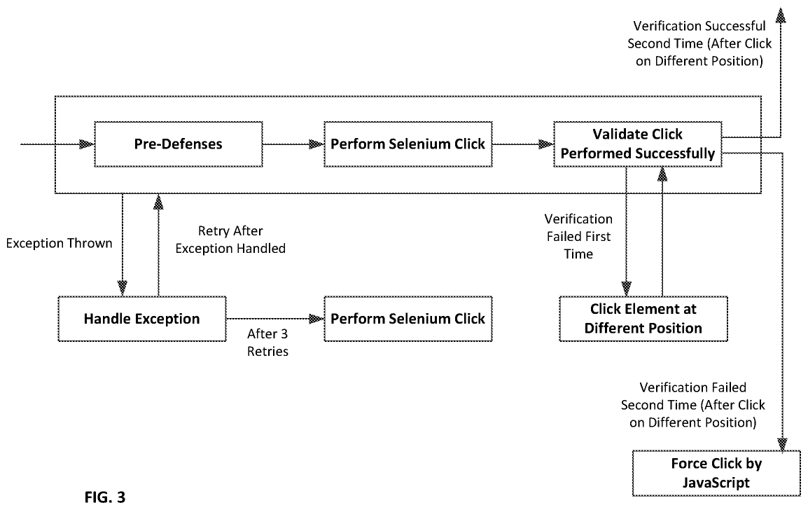

Reference is now made to FIG. 3, where there is shown a flowchart of the main steps executed as part of an exemplary process for performing a test framework (Selenium) ‘Click’, wherein the test is monitored by added or inserted test execution monitoring/control code/functionality, in accordance with some embodiments of the present invention.

Shown process steps include:

(1) Pre-Defense steps, for example: (a) waiting for element visibility; (b) putting element in view port; and/or (c) waiting for element to be enabled.

(2) Validation steps, taken after the selenium Click was performed, for example: (a) if element tag is input and no type is specified or the type is “text” then check if the element is on focus (JavaScript), otherwise the click is valid; and/or, if verification failed, then (b) click element on different position, for example, according to the browser type (Chrome—click at center of element, Firefox—click at the left upper corner of the element).

If the verification is failed another (e.g. second, third . . . ) time, for example after clicking on a different position, then the Click is forced by JavaScript. If the verification is successful, on the first time or after clicking on a different position, associated data is relayed for user reporting/notifying and/or saved for future—executions history related—reference.

(3) Exceptions Handling steps, taken in response to execution exceptions thrown, for example: (a) in response to a Timeout exception (e.g. in waiting for condition at the pre-defenses section)—increasing timeout; (b) in response to a Stale Element exception or No Such Element exception—reallocating element; (c) in response to an Element Not Visible or Element Not Interactable exceptions—putting/positioning element in view port again; and/or (d) in response to an Element Not Clickable At Point exception—clicking on different position according to browser type.

Thrown exceptions are handled and returned for retrying command execution. Upon a successful retry, or threshold number (e.g. 3) of failed retry/retries, the selenium Click is performed.

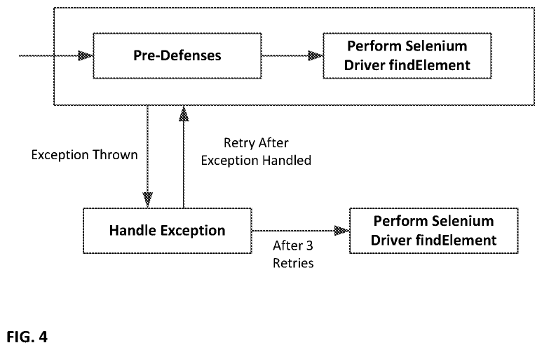

Reference is now made to FIG. 4, where there is shown a flowchart of the main steps executed as part of an exemplary process for performing a test framework (Selenium) ‘Driver findElement’, wherein the test is monitored by added or inserted test execution monitoring/control code/functionality, in accordance with some embodiments of the present invention.

Shown process steps include:

(1) Pre-Defense steps, for example, waiting for element presence; and (2) Exceptions Handling steps, taken in response to execution exceptions thrown, for example: (a) in response to a Timeout exception (e.g. in waiting for condition at the pre-defenses section/step)—increasing timeout; and/or (b) in response to a No Such Element exception—increasing timeout.

Thrown exceptions are handled and returned for retrying command execution. Upon a successful retry, or threshold number (e.g. 3) of failed retry/retries, the selenium Driver findElement is performed.

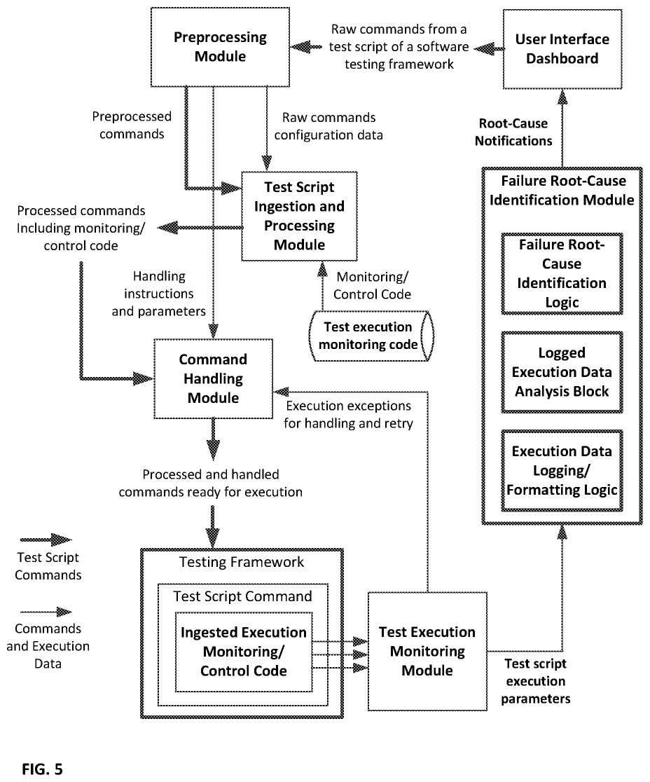

Reference is now made to FIG. 5, where there is shown, in accordance with some embodiments of the present invention, an exemplary System for Enhanced Automated Software Code Testing including a Failure Root-Cause Identification Module.

The Failure Root-Cause Identification Module includes: an execution data logging/formatting logic for logging specific test script execution parameters, received from a test execution monitoring module, in a structured format; a logged execution data analysis block for analyzing the structured data of multiple executions and of a different new execution; and a failure root-cause identification logic for determining the failure root-cause of the different/new execution based on the analysis results. A root-cause notification is shown to be relayed to a user interface dashboard.

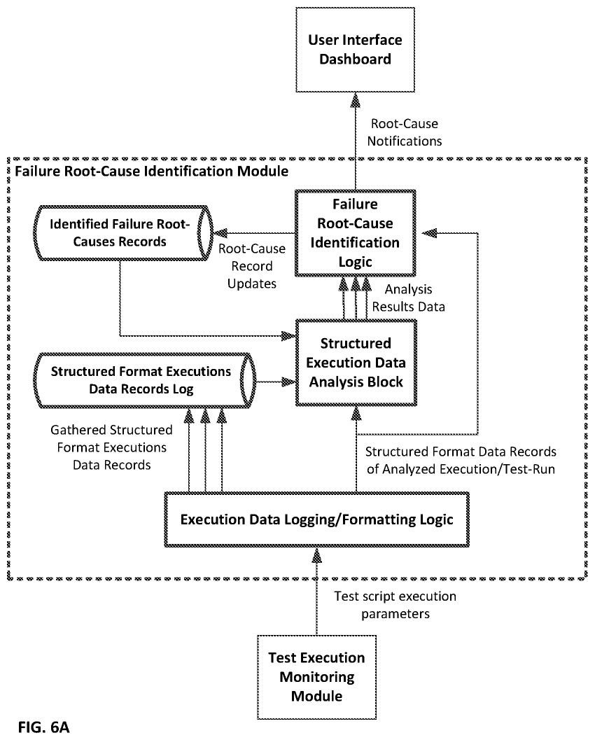

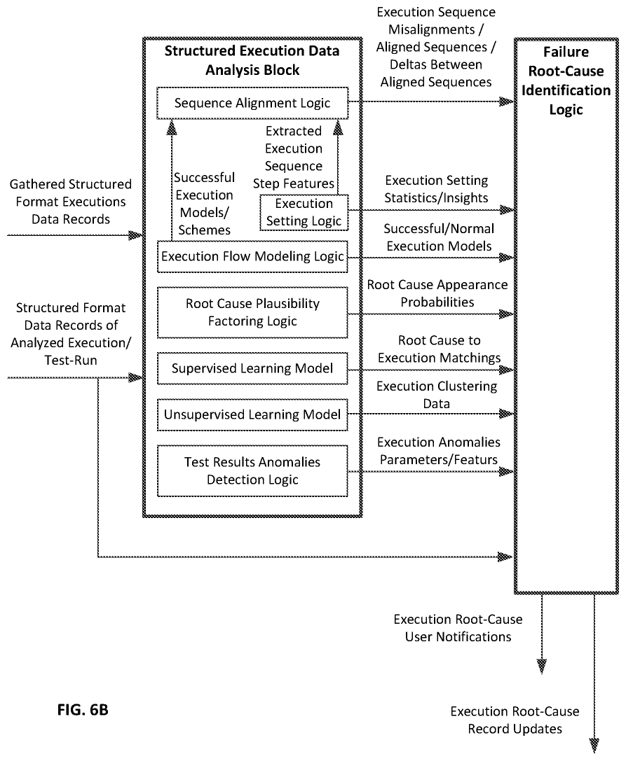

Reference is now made to FIG. 6A, where there is shown in further detail, in accordance with some embodiments of the present invention, an exemplary Failure Root-Cause Identification Module.

The data logging/formatting logic logs the gathered structured format data records, of multiple executions, onto the shown database log. Structured format data records of an analyzed execution/test-run are provided by the logging/formatting logic to the structured execution data analysis block and to the failure root-cause identification logic.

The structured execution data analysis block analyses the structured format data records of a being analyzed execution/test-run, in light of the gathered structured format data records of multiple prior executions and stored records of failure root-cause decisions performed by the system in regard to these multiple prior executions.

The shown failure root-cause identification logic then decides on the failure root-cause associated with the execution being analyzed, based on the results of the analysis. Decided root-cause notification are relayed to the interface of the associated user and updated to the identified failure root-causes records database.

Reference is now made to FIG. 6B, where there is shown in further detail, in accordance with some embodiments of the present invention, an exemplary Structured Execution Data Analysis Block.

Gathered structured format executions data records and structured format data records of analyzed execution/test-run are provided as inputs to the shown analysis logics and models of the structured execution data analysis block and analyzed, as described herein, to provide the following outputs: (1) the sequence alignment logic—execution sequence misalignments; (2) the execution setting logic—execution setting statistics/insights; (3) the execution flow modeling logic—successful/normal execution models; (4) the root cause plausibility factoring logic—root cause appearance probabilities; (5) the supervised learning model—root cause to execution matchings; (6) the unsupervised learning model—execution clustering data; and (7) the test results anomalies detection logic—execution anomalies parameters/features.

The execution setting logic is shown to relay extracted execution sequence step features, for providing relevant step alignment and facilitating executions sequence alignments by the alignment logic. The execution flow modeling logic is shown to rely successful execution models/schemes generated based on multiple previous successful test execution, wherein generated models/schemes are to be aligned with and compared to a currently analyzed failed/errored execution test run, by the sequence alignment logic.

The failure root-cause identification logic shown, receives the analysis results/outputs and applies one or more decision mechanisms to determine one or more failure root-causes associated with the analyzed test script execution. Execution failure root-cause user notifications and database records updates are issued based on the determined root-cause(s).

According to some embodiments of the present invention, a computerized system for automated software code testing failure cause identification, may comprise: a processing module for wrapping test script commands, of a software testing framework, with command execution monitoring or control code, said command execution monitoring or control code, configured to collect test script execution parameters resulting from test script execution; an execution data formatting logic for logging the collected test script execution parameters in a structured format; a structured execution data analysis block for analyzing the structured format parameters; and/or a failure root cause identification logic for automatically determining one or more root causes of a failure in the execution of the test script, based on the results of a comparison between (a) a structured-format execution parameters of a failed test script execution to (b) one or more structured-format execution parameters of prior successful test script executions.

According to some embodiments, the structured execution data analysis block may further comprise a sequence alignment logic for at least partially aligning the sequence of steps or commands executed as part of the failed test script execution with the sequence of steps or commands executed as part of the prior successful test script executions.

According to some embodiments, the structured execution data analysis block may further comprise an execution setting logic for extracting features from steps executed as part of the failed test script and from steps executed as part of the prior successful test script executions.

According to some embodiments, aligning the sequence of steps may at least partially include comparing features extracted from steps executed as part of the failed test script to features extracted from steps executed as part of the prior successful test script executions.

According to some embodiments, a partial match between the features extracted from a step of the failed test script and the features extracted from a step of the prior successful test script executions, may render these steps as corresponding.

According to some embodiments, alignment may include the reordering of the steps of the executed failed test script, such that their order is similar to the order of corresponding steps in one or more of the prior successfully executed test script executions.

According to some embodiments, the failure root cause identification logic may determine the one or more root causes of a failure in the execution of the failed test script, based on differences between execution steps rendered as corresponding.

According to some embodiments, the structured execution data analysis block may further comprise an execution flow modeling logic for generating a single successful test execution scheme based on some or all of the multiple successful test executions; and wherein features extracted from steps executed as part of the failed test script are compared to features extracted from steps executed as part of the test execution scheme generated based on multiple successful test executions.

According to some embodiments, the structured execution data analysis block may further include a supervised learning model, wherein logged test script run records, of multiple failed test runs, are provided to the supervised learning model—along with their respective, previously determined, root causes—as training data; and wherein the trained supervised learning model is utilized to classify the logged-records of a newly executed, failed, test script run to a specific root cause of the failure from within the previously determined root causes.

According to some embodiments of the present invention, a computer implemented method may comprise: wrapping test script commands, of a software testing framework, with command execution monitoring or control code, configured to collect test script execution parameters resulting from the test script execution; logging the collected test script execution parameters in a structured format; and/or analyzing the structured format parameters to automatically identify one or more root causes of a failure in the execution of the test script, wherein root cause identification is based on the results of a comparison between (a) a structured-format logged execution parameters of a failed test script execution and (b) one or more structured-format logged execution parameters of prior successful test script executions.

According to some embodiments, the computer-implemented method may further comprise aligning the sequence of steps or commands executed as part of the failed test script execution with the sequence of steps or commands executed as part of the prior successful test script executions.

According to some embodiments, the computer-implemented method may further comprise extracting features from steps executed as part of the failed test script and from steps executed as part of the prior successful test script executions.

According to some embodiments, aligning the sequence of steps may include comparing features extracted from steps executed as part of the failed test script to features extracted from steps executed as part of the prior successful test script executions.

According to some embodiments, a partial match between the features extracted from a step of the failed test script and the features extracted from a step of the prior successful test script executions, may render these steps as corresponding.

According to some embodiments, alignment may further include the reordering of the steps of the executed failed test script, such that their order is similar to the order of corresponding steps in one or more of the prior successfully executed test script executions.

According to some embodiments, the computer-implemented method may further comprise determining one or more root causes of a failure in the execution of the failed test script, based on differences between execution steps rendered as corresponding.

According to some embodiments, the computer-implemented method may further comprise generating a single successful test execution scheme based on some or all of the multiple successful test executions; and/or comparing features extracted from steps executed as part of the failed test script to features extracted from steps executed as part of the test execution scheme generated based on multiple successful test executions.

According to some embodiments, the computer-implemented method may further comprise providing logged test script run records along with their respective, previously determined, root causes, of multiple failed test runs, to a supervised deep learning model as training data; and/or utilizing the trained supervised deep learning model to classify the logged-records of a newly executed, failed, test script run to a specific root cause of the failure from within the previously determined, root causes.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A computerized system for automated software code testing failure cause identification, said system comprising:
a processing module for wrapping test script commands, of a software testing framework, with command execution monitoring or control code, said command execution monitoring or control code, configured to collect test script execution parameters resulting from test script execution;
an execution data formatting logic for logging the collected test script execution parameters in a structured format;
a structured execution data analysis block for analyzing the structured format parameters; and
a failure root cause identification logic for automatically determining one or more root causes of a failure in the execution of the test script, based on the results of a comparison between (a) a structured-format execution parameters of a failed test script execution to (b) one or more structured-format execution parameters of prior successful test script executions.

2. The system according to claim 1, wherein said structured execution data analysis block further comprises a sequence alignment logic for at least partially aligning a sequence of steps or commands executed as part of the failed test script execution with sequences of steps or commands executed as part of the prior successful test script executions.

3. The system according to claim 2, wherein said structured execution data analysis block further comprises an execution setting logic for extracting features from the steps executed as part of the failed test script and from the steps executed as part of the prior successful test script executions.

4. The system according to claim 3, wherein aligning the sequence of steps at least partially includes comparing the features extracted from the steps executed as part of the failed test script to the features extracted from the steps executed as part of the prior successful test script executions.

5. The system according to claim 4, wherein a partial match between the features extracted from a step of the failed test script and the features extracted from a step of the prior successful test script executions, renders these steps as corresponding.

6. The system according to claim 5, wherein alignment includes the reordering of the steps of the executed failed test script, such that their order is similar to the order of the corresponding steps in one or more of the prior successfully executed test script executions.

7. The system according to claim 6, wherein said failure root cause identification logic determines the one or more root causes of a failure in the execution of the failed test script, based on differences between execution steps rendered as corresponding.

8. The system according to claim 4, wherein said structured execution data analysis block further comprises an execution flow modeling logic for generating a single successful test execution scheme based on some or all of the multiple successful test executions; and
wherein features extracted from the steps executed as part of the failed test script are compared to features extracted from the steps executed as part of the test execution scheme generated based on the multiple successful test executions.

9. The system according to claim 1, wherein said structured execution data analysis block further includes a supervised learning model, wherein logged test script run records, of multiple failed test runs, are provided to said supervised learning model—along with their respective, previously determined, root causes—as training data; and
wherein trained said supervised learning model is utilized to classify the logged-records of a newly executed, failed, test script run to a specific root cause of the failure from within the previously determined root causes.

10. A computer-implemented method comprising:
wrapping test script commands, of a software testing framework, with command execution monitoring or control code, configured to collect test script execution parameters resulting from the test script execution;
logging the collected test script execution parameters in a structured format; and
analyzing the structured format parameters to automatically identify one or more root causes of a failure in the execution of the test script, wherein root cause identification is based on a comparison between (a) a structured-format logged execution parameters of a failed test script execution and (b) one or more structured-format logged execution parameters of prior successful test script executions.

11. The computer-implemented method according to claim 10, further comprising aligning the sequence of steps or commands executed as part of the failed test script execution with the sequence of steps or commands executed as part of the prior successful test script executions.

12. The computer-implemented method according to claim 11, further comprising extracting features from steps executed as part of the failed test script and from steps executed as part of the prior successful test script executions.

13. The computer-implemented method according to claim 12, wherein aligning the sequence of steps includes comparing features extracted from steps executed as part of the failed test script to features extracted from steps executed as part of the prior successful test script executions.

14. The computer-implemented method according to claim 13, wherein a partial match between the features extracted from a step of the failed test script and the features extracted from a step of the prior successful test script executions, renders these steps as corresponding.

15. The computer-implemented method according to claim 14, wherein alignment further includes the reordering of the steps of the executed failed test script, such that their order is similar to the order of corresponding steps in one or more of the prior successfully executed test script executions.

16. The computer-implemented method according to claim 15, further comprising determining one or more root causes of a failure in the execution of the failed test script, based on differences between execution steps rendered as corresponding.

17. The system according to claim 13, further comprising generating a single successful test execution scheme based on some or all of the multiple successful test executions; and
comparing features extracted from steps executed as part of the failed test script to features extracted from steps executed as part of the test execution scheme generated based on multiple successful test executions.

18. The computer-implemented method according to claim 10, further comprising providing logged test script run records along with their respective, previously determined, root causes, of multiple failed test runs, to a supervised deep learning model as training data; and
utilizing the trained supervised deep learning model to classify the logged-records of a newly executed, failed, test script run to a specific root cause of the failure from within the previously determined, root causes.
